(19) United States
(12) Patent Application Publication
(10) Pub. No.: US 2026/0154645 A1
(43) Pub. Date: Jun. 4, 2026

(54) METHOD AND DEVICE WITH AUTONOMOUS MOBILE ROBOT CONTROL

(71) Applicant: Samsung Electronics Co., Ltd., Suwon-si (KR)

(72) Inventors: Sanghoon HAN, Suwon-si (KR); Mingyoung KWANG, Suwon-si (KR); Gangyong GU, Suwon-si (KR); Eungjin KIM, Suwon-si (KR); Taegyu WON, Suwon-si (KR); Minho LEE, Suwon-si (KR); Seunghun HAN, Suwon-si (KR); Cheyun HWANG, Suwon-si (KR)

(73) Assignee: Samsung Electronics Co., Ltd., Suwon-si (KR)

(21) Appl. No.: 19/222,850

(22) Filed: May 29, 2025

(30) Foreign Application Priority Data
Nov. 29, 2024 (KR) 10-2024-0175540

(51) Int. Cl. G06Q 10/0637; G05D 1/69; G06Q 10/0631

(52) U.S. Cl. CPC G06Q 10/06375; G05D 1/69; G06Q 10/06313

(57) ABSTRACT

A method and device with autonomous mobile robot control are provided. The method includes acquiring worker traffic data and environment sensing data of a facility environment that includes a plurality of autonomous mobile robots; generating a dynamic operation profile for the plurality of autonomous mobile robots, based on the acquired worker traffic and environment sensing data; transmitting a control command to the plurality of autonomous mobile robots in accordance with the dynamic operation profile; and updating the dynamic operation profile by adjusting operation parameters of at least some of the plurality of autonomous mobile robots in the facility environment based on the worker traffic data, the environment sensing data, and cost data associated with the facility environment.

### CROSS-REFERENCE TO RELATED APPLICATIONS

This application claims the benefit under 35 USC § 119(a) of Korean Patent Application No. 10-2024-0175540, filed on Nov. 29, 2024, in the Korean Intellectual Property Office, the entire disclosure of which is incorporated herein by reference for all purposes.

### BACKGROUND

### 1. Field

The following description relates to a method and device with autonomous mobile robot control.

### 2. Description of Related Art

Automated guided vehicles (AGVs) may efficiently transport materials and workers on industrial sites, such as manufacturing facilities (e.g., semiconductor clean rooms) and distribution centers. Autonomous mobile robots (AMRs) incorporate advanced sensing and navigation technologies to recognize surrounding environments, avoid obstacles in real time, and adjust their paths in response to environment changes. These capabilities are facilitated by position recognition technologies and sensor systems, which may include cameras, light detection and ranging (LiDAR), and ultrasonic sensors.

The above information is presented as the related art to help with the understanding of the disclosure. No arguments or decisions are raised to whether any of the above description is applicable as the prior art related to the present disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes acquiring worker traffic data and environment sensing data of the facility environment that includes a plurality of autonomous mobile robots; generating a dynamic operation profile for the plurality of autonomous mobile robots, based on the acquired worker traffic and environment sensing data; transmitting a control command to the plurality of autonomous mobile robots in accordance with the dynamic operation profile; and updating the dynamic operation profile by adjusting operation parameters of at least some of the plurality of autonomous mobile robots in the facility environment based on the worker traffic data, the environment sensing data, and cost data associated with the facility environment.

The worker traffic data may include a movement position and a count of workers entering the facility environment.

The environment sensing data may include robot state information of the plurality of autonomous mobile robots and path state information of the facility environment acquired from at least some of the plurality of autonomous mobile robots and sensors within the facility environment.

The generating of the dynamic operation profile may include determining a commercial speed for the plurality of autonomous mobile robots in the facility environment, based on the worker traffic data, the environment sensing data, and performance data of an autonomous mobile robot; determining a round-trip drive time for the plurality of autonomous mobile robots based on the commercial speed; determining the number of service autonomous mobile robots in the facility environment based on the worker traffic data, the environment sensing data, the performance data, and the round-trip drive time; and generating the dynamic operation profile for at least some autonomous mobile robots corresponding to the determined number of service autonomous mobile robots.

The generating of the dynamic operation profile may further include generating the dynamic operation profile by adjusting at least one of a path, a speed, or a driving interval of at least one autonomous mobile robot in an initial dynamic operation profile of the plurality of autonomous mobile robots, the adjustment being based on the worker traffic data and the environment sensing data, which are acquired in real time.

The method may further include transmitting a control command to at least some of the plurality of autonomous mobile robots in accordance with the dynamic operation profile by adjusting at least one of the path, the speed, or the driving interval of at least one autonomous mobile robot in the initial dynamic operation profile.

The updating of the dynamic operation profile may include determining a total profit cost from operating the autonomous mobile robots in the facility environment, based on the worker traffic data and the cost data; determining a target number of service autonomous mobile robots in the facility environment to maximize the total profit cost; and updating the dynamic operation profile by adjusting the operation parameters of at least some of the autonomous mobile robots based on the target number of the service autonomous mobile robots.

The determining of the total profit cost may include determining a profit cost from operating the autonomous mobile robots in the facility environment, based on the worker traffic data; and determining the total profit cost by deducting a loss cost incurred by the autonomous mobile robots in the facility environment from the profit cost, the deduction being based on the environment sensing data and the cost data.

The loss cost incurred by the autonomous mobile robots in the facility environment may include a fixed cost and a variable cost that are associated with operating an autonomous mobile robot in the facility environment.

The method may further include transmitting a control command to the autonomous mobile robots in the facility environment in accordance with the updated dynamic operation profile.

In one general aspect, provided is a non-transitory computer-readable storage medium storing instructions that, when executed by one or more processors of an electronic device individually or collectively, cause the electronic device to perform the method described herein.

In one general aspect, an electronic device includes one or more processors respectively comprising processing circuitry; and memory storing instructions that, when executed by the one or more processors individually or collectively, cause the electronic device to acquire worker traffic data and environment sensing data of the facility environment that includes a plurality of autonomous mobile robots, generate a dynamic operation profile for the plurality of autonomous mobile robots based on the acquired worker traffic and environment sensing data, transmit a control command to the plurality of autonomous mobile robots in accordance with the dynamic operation profile, and update the dynamic operation profile by adjusting operation parameters of at least some of the plurality of autonomous mobile robots in the facility environment, based on the worker traffic data, the environment sensing data, and cost data associated with the facility environment.

The instructions, when executed by the one or more processors individually or collectively, further cause the electronic device to transmit a control command to at least some of the plurality of autonomous mobile robots in accordance with the dynamic operation profile by adjusting the path, the speed, or the driving interval of at least one autonomous mobile robot in the initial dynamic operation profile.

Other features and aspects will be apparent from the following detailed description, the drawings, and the claims.

### BRIEF DESCRIPTION OF THE DRAWINGS

FIG. 1 illustrates an example control system of an autonomous mobile robot according to one or more embodiments.

FIG. 2 illustrates an example method of generating or updating a dynamic operation profile according to one or more embodiments.

FIG. 3 illustrates an example control method according to one or more embodiments.

FIG. 4 illustrates an example method of generating a dynamic operation profile according to one or more embodiments.

FIG. 5 illustrates an example method of updating a dynamic operation profile according to one or more embodiments.

FIG. 6 illustrates an example control device of an autonomous mobile robot according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

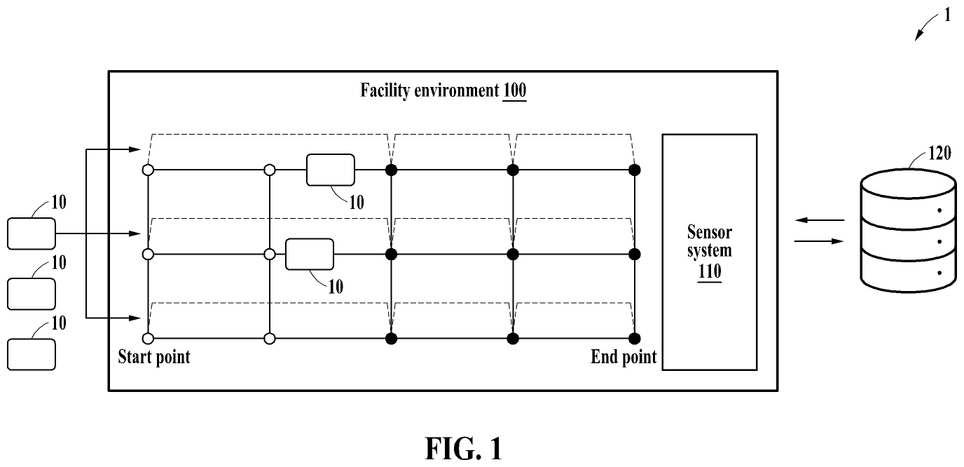

FIG. 1 illustrates an example control system of managing autonomous mobile robots according to one or more embodiments.

In one or more embodiments, a control system 1 (hereinafter, “the system”) may include a facility environment 100 and a control device (hereinafter, “the electronic device”) 120.

The facility environment 100 may be a space including an indoor or outdoor manufacturing facility (e.g., a semiconductor clean room) or a distribution center. As non-limiting examples, the facility environment 100 may include an indoor or outdoor facility such as an airport, port, parking lot, hospital, or hotel. The facility environment 100 may also be a space where multiple users (e.g., workers, users, managers, maintenance workers, or janitors) enter and move.

The facility environment 100 may include the autonomous mobile robots 10 (hereinafter, “robots” in the plural and “robot” in the singular). In the facility environment 100, the robots 10 may transport users and/or items from one point/location to another point/location. In large-scale environments, such as manufacturing facilities, the extended coverage area per worker necessitates the use of the robots 10 to reduce physical movement time and improve resource management.

In the facility environment 100, the robots 10 may transport the users along predetermined routes. For example, the robots 10 may move along designated paths, stopping at one or more locations to load or unload users and/or items.

The facility environment 100 may include various installations (e.g., manufacturing devices or automated machines), establishments (e.g., fences and/or gratings), waiting spaces/areas, and/or charging facilities for the robots 10. The specific configurations of these installations, establishments, structures, and/or spaces may vary depending on maintenance activities, the rate of inflow, or outflow, and the density of users entering the facility environment 100 or the crowd density at a point/location. For example, changes (e.g., dead zones, obstacles, and/or crowd density) on the paths of the facility environment 100 may require adjustments/modifications to the moving paths of the robots 10.

The facility environment 100 may include a sensor system 110, which may include an image sensor (or a camera, such as a closed-circuit television (CCTV) camera), a radio frequency identification (RFID) reader (or an RFID reading station), and/or a distance sensor (e.g., an ultrasonic sensor, a laser sensor such as light detection and ranging (LiDAR), an infrared sensor, and/or a vision-based image sensor). Sensors (e.g., an image sensor, an RFID reader, or a distance sensor) of the sensor system 110 may be deployed/installed at multiple locations/points within the facility environment 100 as part of a sensor module (or a sensor device) including necessary sensor circuitry.

For example, an RFID reader may be installed at an entrance to the facility environment 100. When a worker, using an RFID tag included in the worker's terminal or attached to the worker's identification card, interacts with an RFID reader upon entering the facility environment 100, the RFID reader may generate worker identification data corresponding to the RFID tag.

In one embodiment, the sensor system 110 may process data (e.g., image data, worker identification data, or distance/depth data) generated by the sensors (e.g., image sensor, RFID reader, or distance sensor) of the sensor system 110 to generate worker traffic data indicating the movement position and the number of workers (or users) present in the facility environment 100 as well as environment sensing data indicating the path state information of the facility environment 100 and the robot state information of the robots 10. The sensor system 110 may transmit these data generated by the sensors of the sensor system 110 to the electronic device 120 via wired or wireless communication. The electronic device 120 may process these data to generate worker traffic data and environment sensing data.

For example, cameras (e.g., CCTV cameras) may be installed along paths of the robots 10. The cameras may capture/generate image data of the facility environment 100. By applying deep learning-based processing on captured image data, the sensor system 110 and/or the electronic device 120 may recognize objects (e.g., workers, installations, establishments, and/or loads) and generate worker traffic data indicating the movement position and the number of entered workers corresponding to the recognized object and environment sensing data indicating the path state information of the facility environment 100 and the robot state information of the robots 10. This real-time data processing enables the system to respond dynamically to the control of the robots 10 based on the changes in the facility environment 100, such as variations in worker density, alterations in installations/establishments/structures, and/or modifications in spaces and/or moving paths.

The robots 10 may include an image sensor (or a camera), a distance sensor (e.g., an ultrasonic sensor, a laser sensor such as LiDAR or time-of-flight (ToF), an infrared sensor, or a vision-based image sensor), a velocity sensor (e.g., an encoder or a laser sensor), an acceleration sensor (e.g., an inertial measurement unit (IMU)), a position sensor (e.g., a global positioning system (GPS) or a magnetic field sensor), and/or an RFID reader. These sensors of each of the robots 10 may be installed at one or more locations/points (e.g., front, rear, or side) on each of the robots 10 as part of a sensor module (or a sensor device) including the requisite sensor circuitry. For example, an RFID reader may be installed at a boarding gate of the robot 10. If a worker tags an RFID tag, included in the worker's terminal or attached to the worker's identification card, to the RFID reader when getting in or out of the robot 10, the RFID reader may generate worker identification data corresponding to the RFID tag.

In one or more embodiments, the sensor system 110 may collect or process data (e.g., image data, worker identification data, distance/depth data, velocity or acceleration data, or position data) generated by sensors of the robots 10. By processing these data, the sensor system 110 may generate worker traffic data indicating the movement position of workers and environment sensing data indicating a path state of the facility environment 100 and robot states of the robots 10 and transmit these data to the electronic device 120 via wired or wireless communication. In one or more embodiments, the robots 10 may respectively process their sensor data to generate worker traffic data and environment sensing data and transmit these data to the electronic device 120 via wired or wireless communication. In one or more embodiments, the robots 10 may transmit the data generated by the sensors of the robots 10 to the electronic device 120 via wired or wireless communication, and the electronic device 120 may generate worker traffic data and environment sensing data by processing the data generated by the sensors of the robots 10. In one or more embodiments, the robots 10, the sensor system 110, and the electronic device 120 may each generate a respective portion of the worker traffic data and the environment sensing data, as described above, and the electronic device 120 may acquire the worker traffic data and the environment sensing data based on the accumulated portions.

The electronic device 120 may include one or more processors and a communication module. The one or more processors of the electronic device 120 may execute software (e.g., program, executable code or instruction) to control one or more components (e.g., hardware and/or software components) of the electronic device 120 connected to the one or more processors and may perform various data processing or computations. As part of this data processing or computation, the one or more processors may store instructions or data received from another component (e.g., the communication module) in a volatile memory of the electronic device 120, process the instructions or data, and store result data in a non-volatile memory of the electronic device 120. The communication module of the electronic device 120 may establish a wired or wireless communication channel with the sensor system 100 (or selected components of the sensor system 110), supporting communication via the established communication channel. As a non-limiting example, the communication module may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the sensor system 100 via a short-range wireless communication network (e.g., Bluetooth™, wireless-fidelity (Wi-Fi) direct, or infrared data association (IrDA)) or a long-range communication network (e.g., a legacy cellular network, a 5G network, a next-generation communication network, the Internet, or a computer network (e.g., a LAN or a wide area network (WAN)). In one embodiment, the electronic device 120 may function as a server for the central control of the facility environment 100 (or the robots 10 in the facility environment 100) or a device component included in the server.

In one embodiment, the electronic device 120 may receive the data generated by a sensor (e.g., an image sensor, an RFID reader, or a distance sensor) of the sensor system 110. The electronic device 120 may receive the data generated by the sensors (e.g., an image sensor or a distance sensor) of the robots 10. By processing these data, the electronic device 120 may generate worker traffic data indicating the movement position and/or the number of entered workers in the facility environment 100 and environment sensing data indicating a path state of the facility environment 100 and robot states of the robots 10. According to one or more embodiments, the electronic device 120 may receive worker traffic data and environment sensing data from the sensor system 110 in the facility environment 100. The electronic device 120 may receive environment sensing data from the autonomous mobile robots 10 in the facility environment 100.

Based on the worker traffic and environment sensing data, the electronic device 120 may generate a dynamic operation profile for the robots 10. The dynamic operation profile may include operation parameters such as a path (e.g., a start point, an endpoint, a destination, or a stopping zone/stopping position), a speed, an operation time, a stopping duration, the number of services, and a driving interval (e.g., time interval from when a first robot departs to when a second robot departs) of the robots 10. The path of the robots 10 may include a stopping position and a movement route in the facility environment 100 of each of the robots 10. The dynamic operation profile may be generated and updated in real time during the operation of the robots 10, and the operation parameters included in the dynamic operation profile may be dynamically adjusted to optimize factors such as profits, costs, efficiency, and overall performance.

The electronic device 120 may accumulate and store (or maintain) the worker traffic data and the environment sensing data. Based on these accumulated data, the electronic device 120 may generate or update the dynamic operation profile of the robots 10. The electronic device 120 may transmit a corresponding control command to the robots 10 according to the dynamic operation profile.

Furthermore, the electronic device 120 may continuously update the dynamic operation profile of the robots 10 based on real-time worker traffic data and environment sensing data, which are acquired during the operation and/or idle operation of the robots 10. For example, the electronic device 120 may generate the dynamic operation profile of the robots 10 by updating an initial dynamic operation profile, based on the worker traffic data and the environment sensing data, which are acquired in real time. The electronic device 120 may update the dynamic operation profile additionally, repeatedly, and/or in real time, based on the worker traffic data and the environment sensing data, and may transmit a control command to the robots 10 according to the dynamic operation profile and/or the updated dynamic operation profile. In other words, the initial dynamic operation profile may be refined and updated repeatedly as new data are received, with control commands transmitted to the robots 10 reflecting these real-time adjustments.

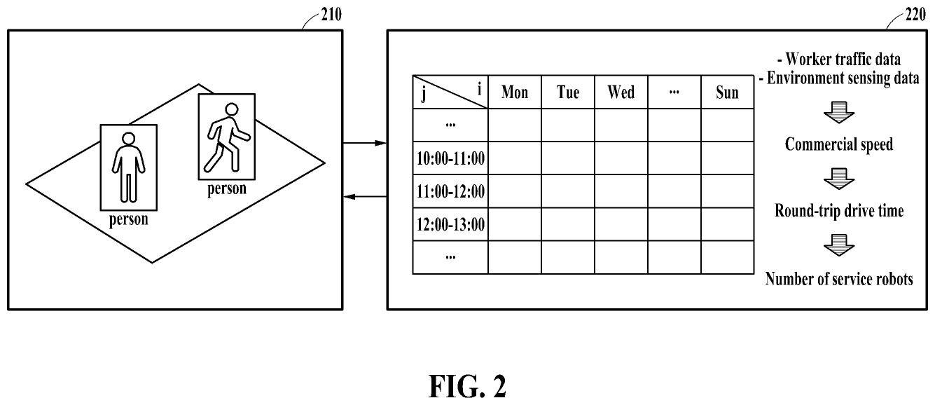

FIG. 2 illustrates an example method of generating or updating a dynamic operation profile according to one or more embodiments.

In operation 210, an electronic device (e.g., the electronic device 120 of FIG. 1) may process data (e.g., image data, worker identification data, distance/depth data) generated by a sensor (e.g., an image sensor, an RFID reader, or a distance sensor) of a sensor system (e.g., the sensor system 110 of FIG. 1) in a facility environment (e.g., the facility environment 100).

The electronic device may detect an object corresponding to a ‘person’ in the facility environment by performing computer vision processing on the image data and/or distance/depth data generated by a sensor of the facility environment. Based on this detection, the electronic device may count the number of objects corresponding to people in the facility environment and may generate worker traffic data indicating the movement positions and the number of workers entering the facility over each time slot or in real time.

By processing the worker identification data generated by a sensor of the facility environment, the electronic device may generate the worker traffic data indicating the number of workers entering the facility environment. As described with reference to FIG. 1, if a worker uses an RFID tag, included in the worker's terminal or attached to the worker's identification card, at an RFID reader upon entering the facility environment, the RFID reader may generate worker identification data corresponding to the RFID tag. The electronic device may then use the worker identification data to generate the worker traffic data indicating the number of entered workers at each time slot or in real time.

The electronic device may process data (e.g., image data, worker identification data, distance/depth data, velocity or acceleration data, or position data) generated by sensors (e.g., image sensor, RFID reader, distance sensor, velocity sensor, acceleration sensor, or position sensor) of robots (e.g., the robots 10 of FIG. 1) in the facility environment.

By processing the image data, distance/depth data, velocity or acceleration data, and/or position data generated by the sensors of the robots, the electronic device may generate environment sensing data indicating a path state (e.g., presence of obstacles, installations resulting from maintenance, dead zones of robots, or closed paths) of the facility environment and a robot state (e.g., speed, stop, avoidance, detour, restart, or charging state of a robot) of the robots for each time slot or in real time.

Similarly, by processing the worker identification data generated by the sensors of the robots, the electronic device may generate the worker traffic data indicating the number of workers entering the facility environment. As described with reference to FIG. 1, if a worker tags an RFID tag, included in the worker's terminal or attached to the worker's identification card, to an RFID reader of the robots when getting in or out of the robots, the RFID reader may generate worker identification data corresponding to the RFID tag. The electronic device may use the worker identification data to generate the worker traffic data indicating the movement positions of workers at each time slot or in real time.

The worker traffic data of the facility environment may include the movement positions and the number of entered workers at each time slot in the facility environment. The worker traffic data may also indicate the workers' demands for boarding the robots. Specifically, the movement positions and the number of entered workers at each time slot or in real time may include the number of workers getting in and/or out of a robot in a stopping zone at each time slot or in real time.

The electronic device may generate (or update) a dynamic operation profile by adjusting a path, a speed, or a driving interval of at least some of the robots, based on the worker traffic data of the facility environment and the environment sensing data of the facility environment, which are acquired in real time during the operation and/or idle operation of the robots. The dynamic operation profile may be generated and updated in real time during the operation of the robots, and the operation parameters of the dynamic operation profiled, which include, but are not limited to, the path, speed, and/or driving interval of the robots, may be dynamically adjusted as needed.

In operation 220, the electronic device may meet the workers' demands for boarding the robots, based on the worker traffic data (e.g., the number of workers boarding the robots at each time slot) and the environment sensing data, and may determine the number of service robots and the driving interval of the service robots adaptive to environmental changes.

The electronic device may determine the commercial speed of the robots in the facility environment, based on the worker traffic data, the environment sensing data, and the performance data of a robot. The electronic device may determine a round-trip time required for a robot to shuttle between designated paths in the facility environment, based on the commercial speed of the robots. Using cost data related to the facility environment and the calculated round-trip drive time of a robot, the electronic device may determine the optimal number of robots in operation and the appropriate driving interval of the robots that meet the workers' demands for boarding the robots.

In one embodiment, based on the worker traffic data and the cost data on the facility environment, the electronic device may introduce robots into the facility environment and may determine a total profit cost associated with operatinging the robots to transport workers and/or items. The electronic device may determine the target number of service robots to maximize the total profit cost from the operating of the autonomous mobile robots in the facility environment. In other words, the electronic device may optimize the number of service robots, and update the dynamic operation profile through the foregoing process.

The electronic device may transmit a control command to the robots in the facility environment based on the updated dynamic operation profile. The electronic device may adjust the dynamic operation profile in real time, even while the robots are operating under the current dynamic operation profile.

The electronic device may repeatedly update the dynamic operation profile. Based on the accumulated data (e.g., the worker traffic data, the environment sensing data, or the adjustment and/or update data on the dynamic operation profile), the electronic device may continuously update the dynamic operation profile of the robots and learn from update patterns. For example, the electronic device may perform modeling on the total profit cost from operating the robots in the facility environment, based on the worker traffic data, the environment sensing data, the commercial speed of the robots, the round-trip drive time, and the number of service robots. In this manner, the electronic device may train a model related to the overall traffic cost of the facility environment, using the collected data and update metrics from the dynamic operation profile.

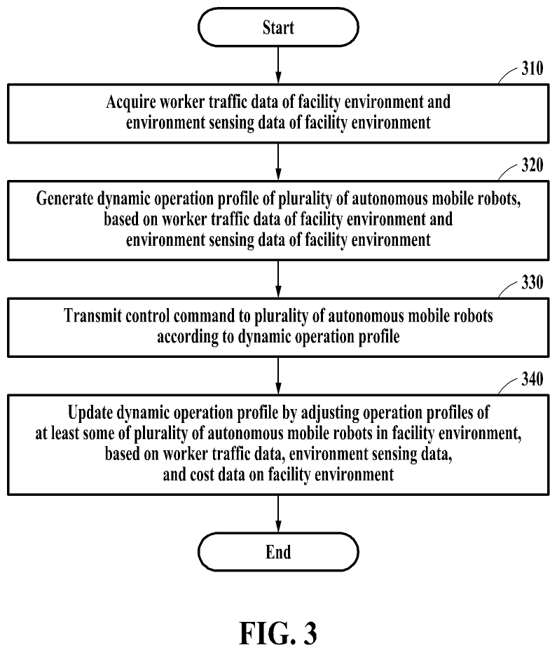

FIG. 3 illustrates an example control method according to one or more embodiments.

In one embodiment, operations 310 to 340 of FIG. 3 may be performed by an electronic device (e.g., the electronic device 120 of FIG. 1).

In operation 310, the electronic device may acquire worker traffic data and environment sensing data from a facility environment (e.g., the facility environment 100 of FIG. 1) that includes a plurality of robots (e.g., the robots 10 of FIG. 1).

As described with reference to FIG. 1, in one embodiment, the electronic device may acquire worker traffic data and environment sensing data from the sensor system 110 in the facility environment 100. Specifically, the electronic device may generate the worker traffic data and the environment sensing data by processing data (e.g., image data, worker identification data, and/or distance/depth data) received from the sensor system 110. In another embodiment, the electronic device may acquire worker traffic data and environment sensing data from the robots 10 in the facility environment 100. Specifically, the electronic device may generate worker traffic data and environment sensing data by processing the data (e.g., the image data, the worker identification data, the distance/depth data, velocity or acceleration data, and/or position data) received from the robots 10. Accordingly, it may be understood that the electronic device ‘acquiring’ the worker traffic data and the environment sensing data includes the electronic device ‘generating’ the worker traffic data and the environment sensing data by processing the data received from the sensor system 110 and/or the autonomous mobile robots 10 in the facility environment 100 or the electronic device ‘receiving’ the worker traffic data and the environment sensing data from the sensor system 100 and/or the autonomous mobile robots 10 in the facility environment 100.

The worker traffic data may include the movement positions and the number of workers entering the facility environment. The worker traffic data may include the movement positions and the number of entered workers, for example, on each day of the week or at each time of the day. The movement positions of workers may include, for example, a position (or a path) moved by the workers on foot, a position (or a path) moved from where the workers get on a robot to where the workers get off the robot, a point where the workers are positioned, and the crowd density of the workers at a location in the facility environment. The movement positions of the workers may include a stopping zone where the workers get on a robot and a stopping zone where the workers get off the robot.

The environment sensing data may include path state information acquired from at least some of the robots and sensors (e.g., image sensor, RFID reader, and/or distance sensor) located throughout the facility environment. The path state information may include elements such as obstacles, installments (e.g., fences or gratings) resulting from maintenance work, equipment (e.g., manufacturing devices or automated machines), robot dead zones, closed paths, or the positions (or movement states) of such elements. In addition, the environment sensing data may include the robot state information (e.g., speed, stop, avoidance, detour, restart, and/or charging state) for each of the robots. The environment sensing data may be data on elements that may affect the control of robot paths and operations.

In one embodiment, operation 310 may be performed in parallel with operations 320 to 340. Operation 310 may be performed continuously during the operation and/or idle operation of the robots.

In operation 320, the electronic device may generate a dynamic operation profile for the robots, based on the acquired worker traffic and environment sensing data of the facility environment.

The dynamic operation profile may include operation parameters such as a path (e.g., start point, endpoint, destination, or stopping zone/position), speed, operation time, stopping time, the number of service robots, or driving interval (e.g., time interval from when a first robot departs to when a second robot departs), of the robots. The path information of the robots may include a stopping position and a movement route for each of the robots in the facility environment.

In one embodiment, the electronic device may generate an initial dynamic operation profile of the robots, based on the worker traffic data and the environment sensing data. The electronic device may transmit a control command to the robots based on this initial dynamic operation profile.

Subsequently, the electronic device may generate the dynamic operation profile by adjusting parameters such as the path, speed, or driving interval of at least one robot in the initial operation profile This adjustments are based on real-time worker traffic and environment sensing data of the facility environment. In other words, the dynamic operation profile is continuously updated from the initial profile as new data become available.

In one or more embodiments, the electronic device may adjust the path of a robot, based on the worker traffic and environment sensing data. For example, the electronic device may reroute the robot to an alternative path with lower density if the crowd density, indicated by the worker traffic data, of workers at a given location exceeds a threshold. For example, the electronic device may adjust the robot's path to another path to make a detour if the environment sensing data indicates the presence of a closed path. For example, the electronic device may adjust the robot's path for avoidance in its position if the environment sensing data indicates the presence of an obstacle or an installment. In such cases, the electronic device may similarly adjust the paths, speeds, and/or driving intervals of other autonomous mobile robots operating along the same route to prevent collisions.

In one or more embodiments, the electronic device may adjust the speed or driving interval of a robot, based on the worker traffic and environment sensing data. For example, if the crowd density, indicated by the worker traffic data, of workers at a stopping position of the robot exceeds the threshold, the electronic device may increase a speed of the robot and/or a subsequent robot that departs after the robot or may shorten driving intervals of other robots driving through the stopping position.

In one or more embodiments, the electronic device may adjust the path, speed, and driving interval of a robot, based solely on the environment sensing data. For example, the electronic device may adjust the path, speed, and driving interval of the robot if the environment sensing data indicate that the charging state of operating robots do not meet a set standard (e.g., between 20% and 80% charged). For example, the electronic device may move/reroute a robot with a low charging state (e.g., 30% to 40%) to a charging facility, thereby ensuring that only robots with an acceptable charge state remain in operation.

The electronic device may update the dynamic operation profile by modifying parameters such as the path, speed, or driving interval of one or more robots, based on real-time worker traffic and environment sensing data. Following such updates, the electronic device may transmit a control command to the robots according to the updated dynamic operation profile.

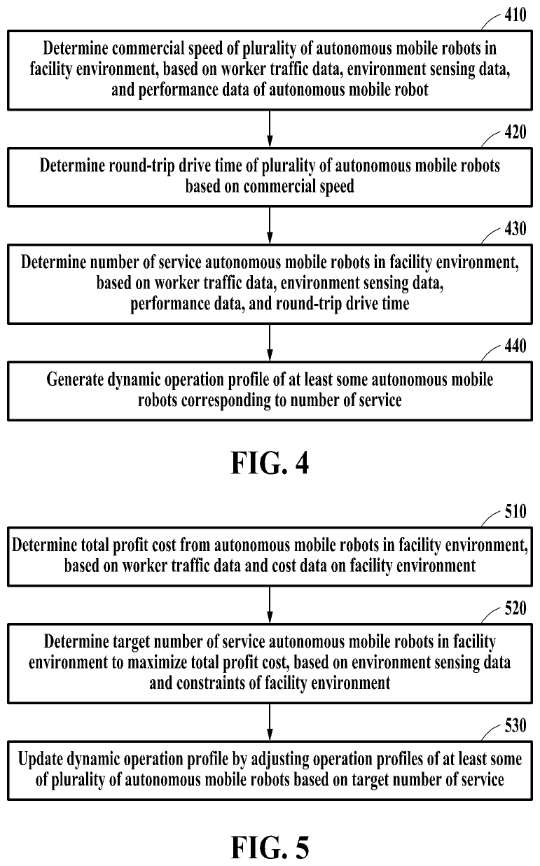

The method of generating a dynamic operation profile is further described in detail with reference to FIG. 4.

In one or more embodiments, operation 320 may be performed continuously during the operation and/or idle operation of the robots.

In operation 330, the electronic device may transmit a control command to the robots based on the dynamic operation profile. The control command may include at least one of updated paths, speeds, or driving intervals of the robots.

In one or more embodiments, the electronic device may transmit a control command to the robots according to an initial dynamic operation profile. In one or more embodiments, the electronic device may transmit a control command to the robots according to the dynamic operation profile generated by updating the initial dynamic operation profile. In one or more embodiments, the electronic device may transmit a control command to the robots according to a subsequently updated dynamic operation profile. For example, the control command may include an adjusted parameter/element corresponding to at least one of path, speed, or driving interval in a previous dynamic operation profile that has been modified relative to a previous profile.

In one embodiment, the electronic device may transmit a control command directly (e.g., via a wireless communication network) to the robots. Alternatively, the facility environment may include a control device (or a control system) configured to control the robots, and the electronic device may transmit a control command to the control device in the facility environment, which in turn forwards the control command to the robots.

In operation 340, the electronic device may update the dynamic operation profile by further adjusting the operation parameters of at least some of the robots based on real-time worker traffic data, the environment sensing data, and cost data on the facility environment. The method of updating a dynamic operation profile is described in detail with reference to FIG. 5.

In response to updating the dynamic operation profile, the electronic device may transmit a control command to the robots in accordance with the updated dynamic operation profile.

In one or more embodiments, the electronic device may repeatedly perform operations 320 to 340, thereby continuously refining the dynamic operation profile based on real-time and accumulated data.

FIG. 4 illustrates an example method of generating a dynamic operation profile according to one or more embodiments.

In one or more embodiments, operations 410 to 440 of FIG. 4 may be performed by an electronic device (e.g., the electronic device 120 of FIG. 1).

In one or more embodiments, operation 320 of generating the dynamic operation profile of FIG. 3 may include operations 410 to 440 of FIG. 4.

In operation 410, the electronic device may determine a commercial speed of a plurality of robots (e.g., the robots 10 of FIG. 1) in a facility environment, based on worker traffic data, environment sensing data, and the performance data of a robot. The performance data of the robot may include maximum speed, acceleration, deceleration, rotation time, charging time, operable time, and capacity of the robot.

A commercial speed V_{eff} of the robots in the facility environment may be expressed by Equation 1, for example.

$${V}_{eff} = \frac{{D}_{avg}}{{T}_{total}} \qquad Equation 1$$

D_{avg} denotes an average operation distance to the destination of a robot and Tₜₒₜₐₗ denotes the total operation time of the robot. The total operation time Tₜₒₜₐₗ of the robot is expressed by Equation 2, for example.

$${T}_{total} = \frac{{D}_{avg} - {D}_{int} - {D}_{bay} - {D}_{blind}}{{V}_{max}} + {T}_{board} \cdot {N}_{p} \cdot 2 + {T}_{turn} + {\sum }_{k = 1}^{n} ( {T}_{avoid}^{( k )} \cdot {N}_{obj}^{( k )} ) + \frac{{D}_{int}}{{V}_{int}} + \frac{{D}_{bay}}{{V}_{bay}} + \frac{{D}_{blind}}{{V}_{blind}} \qquad Equation 2$$

Vₘₐₓ denotes a maximum speed of a robot, T_{board} denotes a time of workers getting in and out of the robot, Nₚ denotes an average number of passengers of the robot, Tₜᵤᵣₙ denotes a detour (or turning) time of the robot,

$${T}_{avoid}^{( k )}$$

denotes an avoiding time of the robot from an object k,

$${N}_{obj}^{( k )}$$

denotes the number of inflow and outflow of the object k, Dᵢₙₜ, D_{bay}, and D_{blind} respectively denote an intersection distance, a distance between stopping zones, and a dead zone distance, and Tᵢₙₜ, T_{bay}, and T_{blind} respectively denote an intersection speed of the robot, a speed of the robot between the stopping zones, and a dead zone speed of the robot.

The electronic device may determine the commercial speed of the robots in the facility environment, based on the worker traffic data (e.g., the average number of passengers of a robot), the environment sensing data (e.g., an average operation distance of the robot, the total operation time of the robot, the time of workers getting in and out of the robot, a detour (or turning) time of the robot, an avoiding time of the robot from the object k, the number of inflow and outflow of the object k, an intersection distance, a distance between stopping zones, a dead zone distance, an intersection speed of the robot, a speed between the stopping zones, and/or a dead zone speed), and the performance data of the robot (e.g., the maximum speed of the robot). The electronic device may determine the commercial speed by dividing an average movement distance over which robots move to a destination by the total operation time of a robot, based on the adjustment (e.g., detour or avoidance from a path, acceleration, deceleration, and/or decrease or increase of a driving interval) of a path, a speed, and/or a driving interval due to factors (e.g., the crowd density of workers, a closed path, or obstacles/installments) indicated by the worker traffic data and the environment sensing data and the performance data of the robot. In other words, the commercial speed may be determined based on an average total time consumed to complete (or perform a task) a path by reaching the destination, including the adjustment of an operation distance, a path, a speed, and/or a driving interval depending on variable surrounding environments, such as the robot adjusting the path to detour or avoid a point with high crowd density of workers, a closed path, or obstacles (or installations), decelerating in a dead zone of the robot, stopping to avoid collision with obstacles, or decreasing or increasing a driving interval in response to the acceleration and deceleration of another robot.

In operation 420, the electronic device may determine a round-trip drive time of the robots based on a commercial speed of the robots in the facility environment. The round-trip drive time refers to a time (or an average time) consumed for the robots to go and return a path in the facility environment.

A round-trip drive time T_{round} of the robots in the facility environment is expressed by Equation 3, for example.

$${T}_{round} = \frac{2 \cdot {D}_{avg}}{{V}_{eff}} + {T}_{wait} \qquad Equation 3$$

D_{avg} denotes an average operation distance to the destination of a robot, V_{eff} denotes the commercial speed of the robots, and T_{wait} denotes a waiting time of the robots.

In operation 430, the electronic device may determine the number of service robots in the facility environment, based on the worker traffic data, the environment sensing data, the performance data of a robot, and the round-trip drive time of the robots.

First, the number N_{cap} of robots that may make a round trip per hour is expressed by Equation 4, for example.

$${N}_{cap} = \frac{{T}_{hour}}{{T}_{round}} \cdot \frac{{T}_{oper}}{{T}_{oper} + {T}_{charge}} \qquad Equation 4$$

Tₕₒᵤᵣ denotes an hourly reference, T_{round} denotes the round-trip drive time of the robots, T_{charge} denotes a charging time of a robot, and Tₒₚₑᵣ denotes an operable time of the robot.

The number of robots that may make a round trip per hour may be determined by using a substantially operable time of one robot according to a charging time of the robot and an operable time of the robot. For example, because the charging time of the robot is longer, the number of robots that may make a round trip per hour may decrease.

The number

$${N}_{req}^{( i , j )}$$

of robots required to satisfy the boarding demands of workers in the facility environment is expressed by Equation 5, for example.

$${N}_{req}^{( i , j )}$$

denotes the number or robots required to satisfy boarding demands by each day i of the week and each time j of the day (or by each time slot) of the workers.

$${N}_{req}^{( i , j )} = ⌈ \frac{{Q}^{( i , j )} \cdot {R}_{occ}}{{N}_{cap} \cdot {C}_{robot}} \cdot ( 1 + \frac{{T}_{charge}}{{T}_{oper}} ) ⌉ \qquad Equation 5$$

Q^{(i,j)} denotes the number of workers (or entered workers) by each day i of the week and each time j of the day (or by each time slot), R_{occ} denotes a boarding rate, N_{cap} denotes the number of robots that may make a round trip per hour, and C_{robot} denotes the capacity of a robot.

The required number of robots at a time slot (or peak hours) with a high population density of workers entering the facility environment may be different from the number of robots at a time slot (or non-peak hours) with a relatively low population density of workers entering the facility environment. The required number of robots during a specific period with high or relatively low work density may also vary. Accordingly, the electronic device may determine the required number of robots to satisfy the boarding demands of workers by each time slot, based on the worker traffic data (e.g., the number of workers by each time slot) of the facility environment, the environment sensing data (e.g., a boarding ratio) of the facility environment, the performance data (e.g., a charging time of a robot, an operable time of the robot, and/or the robot capacity) of the robot, and the round-trip drive time of the robots.

The electronic device may determine the number of service robots in the facility environment by using spatial constraints in the facility environment. The spatial constraints may include the maximum number of robots that may wait in the facility environment and the maximum number of robots that may operate in the facility environment. For example, the electronic device may determine the number of service robots in the facility environment according to Equation 6, for example.

$${N}_{req}^{( i , j )} \leq min ( {C}_{wait} , {C}_{oper} ) \qquad Equation 6$$

C_{wait} denotes the maximum number of robots that may wait in the facility environment and Cₒₚₑᵣ denotes the maximum number of robots that may operate in the facility environment. In this case, the spatial constraints in the facility environment may be adjusted based on the environment sensing data of the facility environment. For example, if the environment sensing data indicates that installments, establishments, structures, and/or spaces are changed, the maximum number of robots that may operate in the facility environment may be adjusted. The electronic device may determine the number of service robots within the maximum number of robots that may wait and/or operate (or be accommodated) in the facility environment while satisfying the boarding demands of workers by each time slot.

In operation 440, the electronic device may generate the dynamic operation profile of at least some robots corresponding to the number of service robots in the facility environment.

In one or more embodiments, the electronic device can generate an initial dynamic operation profile via operations 410 to 440. The electronic device may transmit a control command to the robots according to the initial dynamic operation profile.

The electronic device may generate the dynamic operation profile by adjusting a path, a speed, or a driving interval of at least one robot in an initial dynamic operation profile of the robots, based on real-time worker traffic and environment sensing data of the facility environment. In other words, the electronic device may generate the dynamic operation profile of the robots by updating the initial dynamic operation profile, based on the worker traffic data and environment sensing data of the facility environment, which are acquired in real time. The electronic device may generate a dynamic operation profile by updating the initial dynamic operation profile in real time while robots are operating according to the initial dynamic operation profile.

The electronic device may transmit a control command to at least some of the robots according to the dynamic operation profile by adjusting a path, a speed, or a driving interval of at least one robot in the initial dynamic operation profile.

The electronic device may repeatedly update the dynamic operation profile based on the worker traffic and environment sensing data of the facility environment, which are acquired in real time.

FIG. 5 illustrates an example method of updating a dynamic operation profile according to one or more embodiments.

In one embodiment, operations 510 to 530 of FIG. 5 may be performed by an electronic device (e.g., the electronic device 120 of FIG. 1).

In one embodiment, operation 320 of generating the dynamic operation profile of FIG. 3 may include operations 510 to 530 of FIG. 5.

In operation 510, the electronic device may determine the total profit cost from robots in a facility environment, based on worker traffic data and cost data on the facility environment.

Total profit cost B from robots in the facility environment is expressed by Equation 7, for example.

$$B = {\sum }_{i = 1}^{m} {\sum }_{j = 1}^{n} ( {Q}^{( i , j )} \cdot {V}_{user} - {N}_{oper}^{( i , j )} \cdot ( {C}_{fixed} + {C}_{var} ) - {N}_{idle}^{( i , j )} \cdot {C}_{fixed} ) \qquad Equation 7$$

Q^{(i,j)} denotes the number of workers (or entered workers) by each day i of the week and each time j of the day (or by each time slot), Vᵤₛₑᵣ denotes a profit cost of a worker from a robot,

$${N}_{oper}^{( i , j )}$$

denotes the number of service (or driving) robots by each time slot,

$${N}_{idle}^{( i , j )}$$

denotes the number of idle (or standby) robots by each time slot, C_{fixed} denotes a fixed cost from retaining the robot, and Cᵥₐᵣ denotes a variable cost from the actual operation of the robot. The electronic device can determine a total benefit cost B from robots in the facility environment according to a day i (i is 1 to m) of the week and a time j (j is 1 to n) of the day.

The electronic device calculates the benefit-cost (benefit) of robots in the facility environment based on worker traffic data (e.g. number of workers per hour). Q^{(i,j)}·Vᵤₛₑᵣ) can be determined. Vᵤₛₑᵣ may be calculated based on, for example, a value of a commuting time and/or a waiting time of a worker, a value of a work time reduced by the worker's boarding on a robot, or a value of improved efficiency (e.g., accelerated item delivery, reduced costs in operating a facility or a device, improved emergency response, increased productivity, improved job satisfaction and reduced fatigue of the worker, or improved task efficiency of the worker) of the facility environment from the robot.

The electronic device may determine the total profit cost by deducting a loss cost

$${N}_{oper}^{( i , j )} \cdot ( {C}_{fixed} + {C}_{var} ) + {N}_{idle}^{( i , j )} \cdot {C}_{fixed}$$

from robots in the facility environment from a profit cost Q^{(i,j)}·V^{user} from the robots, based on the environment sensing data and the cost data (e.g., a fixed cost from retaining a robot and a variable cost from the actual operation of the robot) on the facility environment. A loss cost incurred by robots in the facility environment may include a fixed cost and a variable cost of a robot in operation in the facility environment. In this case, the loss cost incurred by robots in the facility environment may include an infrastructure cost of the facility environment, an operation cost of a robot, a cost (e.g., an area) for charging the robot, a maintenance cost, a management personnel cost, a component replacement cost, a depreciation cost, a control system cost, and/or a communication cost.

In operation 520, the electronic device may determine the target number of service robots in the facility environment to maximize the total profit cost from the robots in the facility environment, based on the environment sensing data and the constraints of the facility environment.

The constraints of the facility environment may include spatial constraints (e.g., the maximum number of robots that may wait in the facility environment and the maximum number of robots that may operate in the facility environment) in the facility environment and the number of retained robots.

The electronic device may determine the target number of service robots in the facility environment to maximize the total profit cost from the robots in the facility environment, for example, while satisfying the following conditions, based on the environment sensing data and the constraints of the facility environment.

$${N}_{oper}^{( i , j )} + {N}_{idle}^{( i , j )} = {N}_{total} , ∀ i ∈ \{ 1 , … , m \} , ∀ j ∈ \{ 1 , … , n \} \qquad Condition 1$$

$${N}_{oper}^{( i , j )} \leq {C}_{oper} , ∀ i , j \qquad Condition 2$$

$${N}_{idle}^{( i , j )} \leq {C}_{wait} , ∀ i , j \qquad Condition 3$$

$${N}_{total} \leq min ( {C}_{oper} , {C}_{wait} ) \qquad Condition 4$$

Nₜₒₜₐₗ denotes the total number of retained robots,

$${N}_{oper}^{( i , j )}$$

denotes the number or service (or driving) robots by each time slot,

$${N}_{idle}^{( i , j )}$$

denotes the number or idle (or standby) robots by each time slot, C_{wait} denotes the maximum number of robots that may wait in the facility environment, and Cₒₚₑᵣ denotes the maximum number of robots that may operate in the facility environment. The electronic device may determine the number of service (or driving) robots by each time slot to maximize the total profit cost B according to [Equation 7] to be the target number of service robots while satisfying the total number Nₜₒₜₐₗ of retained robots, which is less than or equal to the maximum number of robots that may wait in the facility environment and the maximum number of robots that may operate in the facility environment.

In this case, the constraints of the facility environment may be adjusted based on the environment sensing data of the facility environment. For example, if the environment sensing data indicates that installments, establishments, structures, and/or spaces are changed, the maximum number of robots that may operate in the facility environment may be adjusted. In addition, the constraints of the facility environment may be adjusted depending on factors, such as a road plan of the facility environment, the number of lanes, whether there is a dedicated road, or whether a dedicated road is separated.

The electronic device may model the total benefit cost from robots in the facility environment according to [Equation 7] and Conditions 1 to 4. The electronic device may determine the optimal number (the target number) of service robots to satisfy the boarding demands of workers while satisfying the constraints of the facility environment in addition to maximizing the total profit cost from robots.

In operation 530, the electronic device may update the dynamic operation profile by adjusting the operation profiles of at least some of the robots based on the target number of service robots that maximizes the total profit cost from the robots in the facility environment.

The electronic device may update the dynamic operation profile by adjusting the operation profiles, such as a path (e.g., a start point, an endpoint, a destination, or a stopping zone/position), a speed, an operation time, a stopping time, the number of service robots, or a driving interval (e.g., time interval from when a first robot departs to when a second robot departs) of at least some of the robots, based on the target number of service robots.

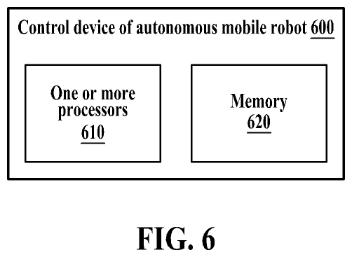

FIG. 6 illustrates an example control device of a robot according to one or more embodiments.

The control device (hereinafter, the “electronic device” 600) of the robot may perform the control method described above. As described with reference to FIG. 1, in one or more embodiments, the electronic device 600 may acquire worker traffic data and environment sensing data from the sensor system 110 within the facility environment 100. In some embodiments, the electronic device 600 may generate the worker traffic data and the environment sensing data by processing data (e.g., image data, worker identification data, or distance (or depth) data) received from the sensor system 110 within the facility environment 100. In some embodiments, the electronic device 600 may acquire worker traffic data and environment sensing data from the robots 10 operating in the facility environment 100. In some embodiments, the electronic device 600 may generate worker traffic data and environment sensing data by processing the data (e.g., the image data, the worker identification data, the distance (or depth) data, velocity or acceleration data, or position data) received from the robots 10 operating in the facility environment 100.

The electronic device 600 may generate a dynamic operation profile for a plurality of robots (e.g., the robots 10 of FIG. 1) based on the worker traffic data and the environment sensing data of the facility environment. The electronic device 600 may transmit a control command to the robots according to the generated dynamic operation profile.

The electronic device 600 may update the dynamic operation profile by adjusting the operation parameters of the robots within the facility environment based on the worker traffic data, the environment sensing data, and cost data associated with the facility environment. The electronic device 600 may transmit an updated control command to the robots in accordance with the revised/updated dynamic operation profile.

The electronic device 600 may include one or more processors 610 and a memory 620. The one or more processors 610 may include at least one processor including processing circuitry. The memory 620 may include one or more storage media configured to store instructions. When the instructions are executed, either individually or in combination, by the one or more processors 610, the electronic device 200 may perform at least a portion of the operations described with reference to FIGS. 1 to 4.

The electronic device 600 may include a communicator (not shown) that is operatively coupled to the one or more processors 610 and the memory 620 for transmitting and receiving data. The communicator may also be coupled to an external device for exchanging data with said device. Hereinafter, the term “transmitting and receiving ‘A’” shall refer to transmitting and receiving “information or data indicating A”.

The communicator may be implemented as circuitry in the electronic device 600. For example, the communicator may include both an internal bus and an external bus. For another example, the communicator may be configured as an interface connecting the electronic device 600 to an external device (e.g., the sensor system 110 or the robots 10 depicted in FIG. 1). The communicator may receive data from the external device and transmit such data to the one or more processors 610 and the memory 620.

The one or more processors 610 may process data received by the communicator and stored in the memory 620. As used herein, each of the “one or more processors” described herein may be a hardware-implemented data processing device having a physically structured circuit to execute desired operations. Such operations may include executing code or instructions contained in a program. As a non-limiting example, the hardware-implemented data processing device may include a microprocessor, a central processing unit (CPU), a graphics processing unit (GPU), a processor core, a multi-core processor, a multiprocessor, an application-specific integrated circuit (ASIC), or a field-programmable gate array (FPGA).

The one or more processors 610 may control other components (both hardware and software) of the electronic device 600 and perform various types of data processing or operations. In one or more embodiments, the processor 610 may store instructions or data received from another component (e.g., the communicator) into the memory 620, process the instructions or the data, and store the resulting data back in the memory 620. Thus, the operations performed by the processor 610 may be substantially equivalent to the operations of the electronic device 600.

The memory 620 may store information necessary for the one or more processors 610 to perform its processing operations. The memory 620 (or one or more storage media incorporated therein) may store instructions executed by the one or more processors 610 and related information while software or a program is executed by the electronic device 600. As a non-limiting example, the memory 620 may include one or more memories, which are volatile and/or non-volatile memories known in the art (e.g., random-access memory (RAM), dynamic RAM (DRAM), static RAM (SRAM), non-volatile RAM (NVRAM), persistent memory (PMEM), magneto-resistive RAM (MRAM), high bandwidth memory (HBM), or 3DXPoint).

Additionally, the electronic device 600 may be connected to an external memory via the communicator. The external memory may include one or more types of volatile and non-volatile memories (e.g., RAM, flash memories, hard disk drives, and optical disc drives). The external memory may store an instruction set (e.g., software) for operating the electronic device 600. The instruction set for operating the electronic device 600 may be executed by the one or more processors 610.

The sensors, cameras, processors, memories, communication interfaces, electronic devices, robot 10, facility environment 100, sensor system 110, electronic device 120, processors 610, memory 620 and other components described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (i.e., code) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-6 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
acquiring worker traffic data and environment sensing data of a facility environment that includes a plurality of autonomous mobile robots;
generating a dynamic operation profile for the plurality of autonomous mobile robots, based on the acquired worker traffic and environment sensing data;
transmitting a control command to the plurality of autonomous mobile robots in accordance with the dynamic operation profile; and
updating the dynamic operation profile by adjusting operation parameters of at least some of the plurality of autonomous mobile robots in the facility environment based on the worker traffic data, the environment sensing data, and cost data associated with the facility environment.

2. The method of claim 1, wherein the worker traffic data comprises a movement position and a count of workers entering the facility environment.

3. The method of claim 1, wherein the environment sensing data comprises robot state information of the plurality of autonomous mobile robots and path state information of the facility environment acquired from at least some of the plurality of autonomous mobile robots and sensors within the facility environment.

4. The method of claim 1, wherein the generating of the dynamic operation profile comprises:
determining a commercial speed for the plurality of autonomous mobile robots in the facility environment, based on the worker traffic data, the environment sensing data, and performance data of an autonomous mobile robot;
determining a round-trip drive time for the plurality of autonomous mobile robots based on the commercial speed;
determining the number of service autonomous mobile robots in the facility environment based on the worker traffic data, the environment sensing data, the performance data, and the round-trip drive time; and
generating the dynamic operation profile for at least some autonomous mobile robots corresponding to the determined number of service autonomous mobile robots.

5. The method of claim 4, wherein the generating of the dynamic operation profile further comprises:
generating the dynamic operation profile by adjusting any one or any combination of any two or more of a path, a speed, and a driving interval of one or more autonomous mobile robots in an initial dynamic operation profile of the plurality of autonomous mobile robots, the adjustment being based on the worker traffic data and the environment sensing data, which are acquired in real time.

6. The method of claim 5, further comprising:
transmitting a control command to at least some of the plurality of autonomous mobile robots in accordance with the dynamic operation profile by adjusting any one or any combination of any two or more of the path, the speed, and the driving interval of one or more autonomous mobile robots in the initial dynamic operation profile.

7. The method of claim 1, wherein the updating of the dynamic operation profile comprises:
determining a total profit cost from operating the autonomous mobile robots in the facility environment, based on the worker traffic data and the cost data;
determining a target number of service autonomous mobile robots in the facility environment to maximize the total profit cost; and
updating the dynamic operation profile by adjusting the operation parameters of at least some of the autonomous mobile robots based on the target number of the service autonomous mobile robots.

8. The method of claim 7, wherein the determining of the total profit cost comprises:
determining a profit cost from operating the autonomous mobile robots in the facility environment, based on the worker traffic data; and
determining the total profit cost by deducting a loss cost incurred by the autonomous mobile robots in the facility environment from the profit cost, the deduction being based on the environment sensing data and the cost data.

9. The method of claim 8, wherein the loss cost incurred by the autonomous mobile robots in the facility environment comprises a fixed cost and a variable cost that are associated with operating an autonomous mobile robot in the facility environment.

10. The method of claim 1, further comprising:
transmitting a control command to the autonomous mobile robots in the facility environment in accordance with the updated dynamic operation profile.

11. A non-transitory computer-readable storage medium storing instructions that, when executed by one or more processors of an electronic device individually or collectively, cause the electronic device to perform the method of claim 1.

12. An electronic device comprising:
one or more processors respectively comprising processing circuitry; and
memory storing instructions that, when executed by the one or more processors individually or collectively, cause the electronic device to:
acquire worker traffic data and environment sensing data of the facility environment that includes a plurality of autonomous mobile robots,
generate a dynamic operation profile for the plurality of autonomous mobile robots based on the acquired worker traffic and environment sensing data,
transmit a control command to the plurality of autonomous mobile robots in accordance with the dynamic operation profile, and
update the dynamic operation profile by adjusting operation parameters of at least some of the plurality of autonomous mobile robots in the facility environment, based on the worker traffic data, the environment sensing data, and cost data associated with the facility environment.

13. The electronic device of claim 12, wherein the worker traffic data comprises a movement position and a count of workers entering the facility environment.

14. The electronic device of claim 12, wherein the environment sensing data comprises robot state information of the plurality of autonomous mobile robots and path state information of the facility environment acquired from at least some of the plurality of autonomous mobile robots and sensors within the facility environment.

15. The electronic device of claim 12, wherein, for the generating of the dynamic operation profile, the instructions, when executed by the one or more processors individually or collectively, further cause the electronic device to:
determine a commercial speed for the plurality of autonomous mobile robots in the facility environment, based on the worker traffic data, the environment sensing data, and performance data of an autonomous mobile robot;
determine a round-trip drive time for the plurality of autonomous mobile robots based on the commercial speed;
determine the number of service autonomous mobile robots in the facility environment based on the worker traffic data, the environment sensing data, the performance data, and the round-trip drive time; and
generate the dynamic operation profile for at least some autonomous mobile robots corresponding to the number of service autonomous mobile robots.

16. The electronic device of claim 15, wherein, for the generating of the dynamic operation, the instructions, when executed by the one or more processors individually or collectively, further cause the electronic device to:
generate the dynamic operation profile by adjusting at least one of a path, a speed, or a driving interval of at least one autonomous mobile robot in an initial dynamic operation profile of the plurality of autonomous mobile robots, based on the worker traffic data and the environment sensing data, which are acquired in real time.

17. The electronic device of claim 16, wherein the instructions, when executed by the one or more processors individually or collectively, further cause the electronic device to:
transmit a control command to at least some of the plurality of autonomous mobile robots in accordance with the dynamic operation profile by adjusting the path, the speed, or the driving interval of at least one autonomous mobile robot in the initial dynamic operation profile.

18. The electronic device of claim 12, wherein, for the updating of the dynamic operation profile, the instructions, when executed by the one or more processors individually or collectively, further cause the electronic device to:
determine a total profit cost from operating the autonomous mobile robots in the facility environment, based on the worker traffic data and the cost data;
determine a target number of service autonomous mobile robots in the facility environment to maximize the total profit cost; and
update the dynamic operation profile by adjusting the operation parameters of at least some of the plurality of autonomous mobile robots based on the target number of service autonomous mobile robots.

19. The electronic device of claim 18, wherein, for the determining of the total profit cost, the instructions, when executed by the one or more processors individually or collectively, further cause the electronic device to:
determine a profit cost from operating the autonomous mobile robots in the facility environment, based on the worker traffic data; and
determine the total profit cost by deducting a loss cost incurred by the autonomous mobile robots in the facility environment from the profit cost, based on the environment sensing data and the cost data.

20. The electronic device of claim 19, wherein the loss cost incurred by the autonomous mobile robots in the facility environment comprises a fixed cost and a variable cost that are associated with operating an autonomous mobile robot in the facility environment.
